(19) United States
(12) Patent Application Publication
(10) Pub. No.: US 2022/0071435 A1
(43) Pub. Date: Mar. 10, 2022

(54) FLIP LID COFFEE MACHINE

(71) Applicant: Cheng Uei Precision Industry Co., LTD., New Taipei City (TW)

(72) Inventor: Chi-Ming Tseng, New Taipei City (TW)

(21) Appl. No.: 17/386,431

(22) Filed: Jul. 27, 2021

(30) Foreign Application Priority Data
Sep. 9, 2020 (CN) 202021961607.3

(51) Int. Cl. A47J 31/36; A47J 31/44; A47J 31/52; A47J 31/06; A47J 31/46; B26F 1/18; H04N 5/232; G06K 7/14; G06K 7/10

(52) U.S. Cl. CPC A47J 31/3695; A47J 31/4407; A47J 31/5255; A47J 31/4492; A47J 31/0673; G06K 7/10722; A47J 31/46; B26F 1/18; H04N 5/23218; G06K 7/1417; A47J 31/0678

(57) ABSTRACT

A flip lid coffee machine includes a base body, a holding container, a cover pivotally connected to the base body, an actuator, an image sensing camera and a control device. The cover has a pivot end, a free end and a cutting membrane structure arranged between the pivot end and the free end. The cutting membrane structure includes a blade holder, a plurality of the water outlets arranged around a periphery of the blade holder, and a plurality of blades arranged around the periphery of the blade holder and corresponding to the plurality of the water outlets. The actuator is connected between the base body and the pivot end of the cover. The image sensing camera is arranged at the free end of the cover. The control device is connected with the actuator and the image sensing camera.

### CROSS-REFERENCE TO RELATED APPLICATION

The present application is based on, and claims priority from, China Patent Application No. 202021961607.3, filed Sep. 9, 2020, the disclosure of which is hereby incorporated by reference herein in its entirety.

### BACKGROUND OF THE INVENTION

### 1. Field of the Invention

The present invention generally relates to a coffee maker field, and more particularly to a flip lid coffee machine which is a flip lid capsule coffee machine, and the flip lid coffee machine has a cover automatically flipped, and has a piercement structure.

### 2. The Related Art

Currently, procedures of a user using a conventional capsule coffee machine on the market is mostly shown as follows: firstly, lift and open an upper cover manually, secondly, place a coffee capsule in the conventional capsule coffee machine, thirdly, close the upper cover manually, fourthly, touch a function button to extract a coffee, fifthly, lift and open the upper cover manually after completing extracting the coffee, and discard a capsule for holding the coffee, and sixthly, close the upper cover manually. Thus, it can be seen that the user need complete six steps to extract the coffee once, the user needs to manually lift and close the upper cover for four times, and simultaneously, a certain amount of force is needed to lift the upper cover, it is inconvenient and inefficient for the user to use the conventional capsule coffee machine.

Besides, two sides of a holding container of the conventional capsule coffee machine are equipped with two piercement structures, nevertheless, after one piercement structure disposed to an upper end of the holding container of the conventional capsule coffee machine pierces a coffee capsule membrane, so that hot water flows from a hot water pipe into the coffee capsule through the pierced coffee capsule membrane, and the water from the hot water pipe vertically flows downward that causes the hot water to be overly concentrated on impacting partial coffee particles and results in an over-extraction problem and an uneven extraction problem of the partial coffee particles.

Therefore, it is especially important to provide a flip lid coffee machine which is a flip lid capsule coffee machine, and the flip lid coffee machine is easy to use, and a coffee is more uniformly extracted and is able to be brewed evenly.

### SUMMARY OF THE INVENTION

An object of the present invention is to provide a flip lid coffee machine. The flip lid coffee machine includes a base body, a holding container penetrating through an upper surface of the base body, a cover movably and pivotally connected to the upper surface of the base body, an actuator, an image sensing camera and a control device. The cover has a pivot end that is pivotally connected to the base body, a free end opposite to the pivot end, and a cutting membrane structure arranged between the pivot end and the free end. When the cover is covered on the upper surface of the base body, the cutting membrane structure is aligned with the holding container. The cutting membrane structure includes a blade holder, a plurality of the water outlets and a plurality of blades. The plurality of the water outlets are arranged around a periphery of the blade holder. The plurality of the blades are arranged around the periphery of the blade holder and corresponding to the plurality of the water outlets. Each blade is disposed corresponding to a water flowing direction of one water outlet for guiding a water stream. And an oblique angle is formed between the cover and a top surface of the holding container. The actuator is connected between the base body and the pivot end of the cover. The image sensing camera is arranged at and exposed to the free end of the cover. The holding container has a connecting hole penetrating through the top surface of the holding container. When the cover is moved to a range of the oblique angle, the image sensing camera is towards the connecting hole of the holding container. The control device is connected with and communicates with the actuator and the image sensing camera. The control device includes an image processing unit for receiving image data and proceeding with an image recognition, and a microprocessor for processing confirmation data and starting the actuator.

Another object of the present invention is to provide a flip lid coffee machine adapted for extracting coffee from a coffee capsule. The flip lid coffee machine includes a base body, a holding container mounted to an upper surface of the base body, a cover movably and pivotally connected to the upper surface of the base body, an actuator, an image sensing camera and a control device. The cover has a pivot end that is pivotally connected to the base body, a free end opposite to the pivot end, and a cutting membrane structure arranged between the pivot end and the free end. When the cover is covered on the upper surface of the base body, the cutting membrane structure is aligned with the holding container. The cutting membrane structure includes a blade holder, a plurality of the water outlets and a plurality of blades. The plurality of the water outlets are arranged around a periphery of the blade holder. The plurality of the blades are arranged around the periphery of the blade holder and corresponding to the plurality of the water outlets. Each blade is disposed corresponding to a water flowing direction of one water outlet for guiding a water stream. The cover is movable with respect to the holding container, and an oblique angle is formed between the cover and a top surface of the holding container. The actuator is connected between the base body and the pivot end of the cover. The image sensing camera is arranged at and exposed to the free end of the cover. The holding container has a connecting hole penetrating through the top surface of the holding container for receiving the coffee capsule. When the cover is moved to a range of the oblique angle, the image sensing camera is towards the connecting hole of the holding container. The control device is connected with and communicates with the actuator and the image sensing camera. The control device includes an image processing unit for receiving image data and proceeding with an image recognition, and a microprocessor for processing confirmation data and controlling the actuator. The cover rotates within the range of the oblique angle to make the image sensing camera be towards the holding container and capture a two-dimension bar code on a top membrane of the coffee capsule.

Another object of the present invention is to provide a flip lid coffee machine. The flip lid coffee machine includes a base body, a holding container mounted to an upper surface of the base body, a cover movably and pivotally connected to the upper surface of the base body, an actuator, an image sensing camera and a control device. The cover has a pivot end that is pivotally connected to the base body, a free end opposite to the pivot end, and a cutting membrane structure arranged between the pivot end and the free end. When the cover is covered on the upper surface of the base body, the cutting membrane structure is aligned with the holding container. The cutting membrane structure includes a blade holder, a plurality of the water outlets, a plurality of blades and a plurality of hot water conduits. The plurality of the water outlets are arranged around a periphery of the blade holder. The plurality of the blades are arranged around the periphery of the blade holder and corresponding to the plurality of the water outlets. Each blade is disposed corresponding to a water flowing direction of one water outlet for guiding a water stream. The plurality of the hot water conduits are disposed around an assembling surface of the blade holder opposite to the holding container. The plurality of the hot water conduits are corresponding to the plurality of the water outlets. And an oblique angle is formed between the cover and a top surface of the holding container. The actuator is connected between the base body and the pivot end of the cover. The image sensing camera is arranged at and exposed to the free end of the cover. The holding container has a connecting hole penetrating through the top surface of the holding container. When the cover is moved to a range of the oblique angle, the image sensing camera is towards the connecting hole of the holding container and captures a two-dimension bar code on a top membrane of a coffee capsule positioned in the holding container. The control device is connected with and communicates with the actuator and the image sensing camera. The control device includes an image processing unit for receiving image data of the captured two-dimension bar code and proceeding with an image recognition of the captured two-dimension bar code, and a microprocessor for processing confirmation data of the captured two-dimension bar code and controlling the actuator.

As described above, in a process of the flip lid coffee machine extracting coffee, the image sensing camera captures the two-dimension bar code on the top membrane of the coffee capsule, so the flip lid coffee machine is easy to use. Moreover, the plurality of the water outlets are arranged around the periphery of the blade holder, the plurality of the blades are arranged around the periphery of the blade holder and corresponding to the plurality of the water outlets, and the plurality of the hot water conduits are corresponding to the plurality of the water outlets, so the coffee is more uniformly extracted and is able to be brewed evenly.

### BRIEF DESCRIPTION OF THE DRAWINGS

The present invention will be apparent to those skilled in the art by reading the following description, with reference to the attached drawings, in which:

FIG. 1 is a perspective view of a flip lid coffee machine in accordance with a preferred embodiment of the present invention;

FIG. 2 is a sectional view of the flip lid coffee machine along a line A-A shown of FIG. 1;

FIG. 3 is a partially sectional view of the flip lid coffee machine in accordance with the present invention, wherein an upper portion of the flip lid coffee machine is shown;

FIG. 4 is another partially sectional view of the flip lid coffee machine in accordance with the present invention, wherein an upper ring is covered to a top of a holding container of the flip lid coffee machine;

FIG. 5 is an enlarged view of an encircled portion V of the flip lid coffee machine of FIG. 4;

FIG. 6 is a partially perspective view of the flip lid coffee machine;

FIG. 7 is a perspective view of a cover of the flip lid coffee machine in accordance with the present invention; and

FIG. 8 is a block diagram which shows a control device of the flip lid coffee machine, wherein the control device is connected with an actuator.

### DETAILED DESCRIPTION OF THE PREFERRED EMBODIMENT

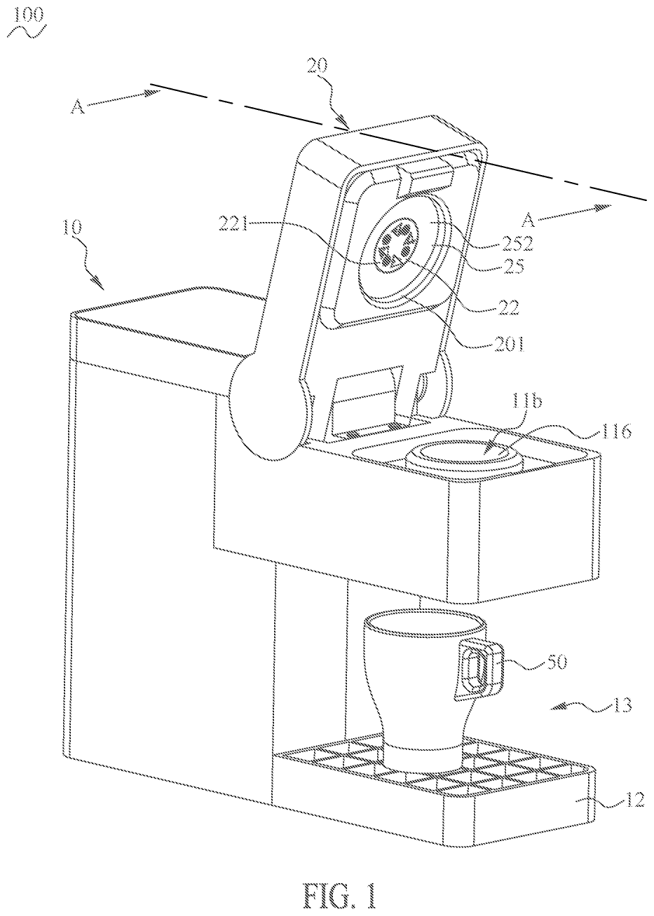

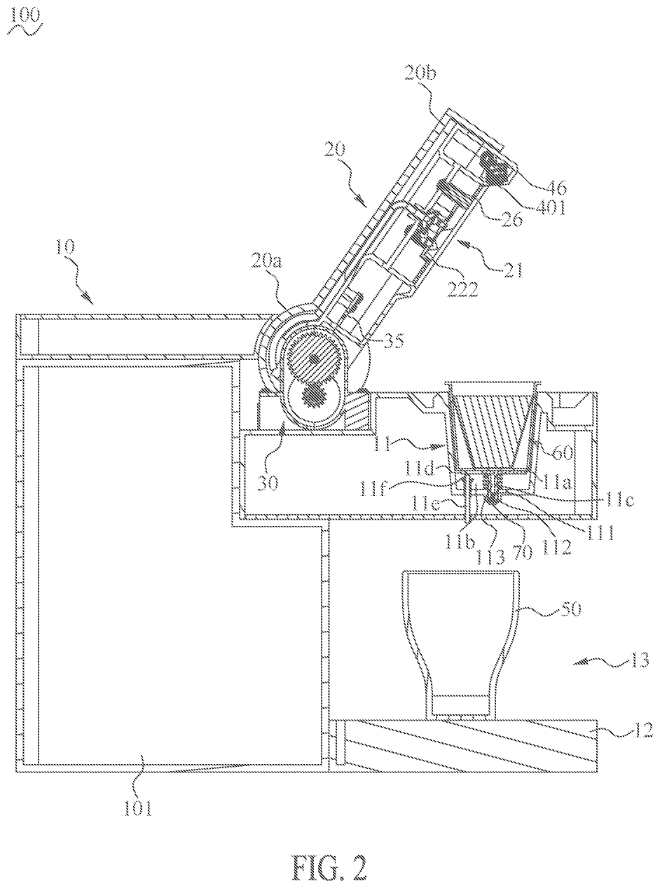

Referring to FIG. 1 and FIG. 2, a flip lid coffee machine 100 in accordance with a preferred embodiment of the present invention is shown. The flip lid coffee machine 100 is adapted for extracting coffee from a coffee capsule 60. The flip lid coffee machine 100 includes a base body 10, and a cover 20 movably and pivotally connected to an upper surface of the base body 10.

The base body 10 includes a rectangular main element 101. An upper portion of one side of the main element 101 of the base body 10 is equipped with a holding container 11. The holding container 11 is mounted to the upper surface of the base body 10. The holding container 11 penetrates through the upper surface of the base body 10. A top end of the holding container 11 has a connecting hole 116 penetrating through a top surface of the holding container 11 for receiving the coffee capsule 60. A lower portion of the one side of the main element 101 of the base body 10 is equipped with a supporting bracket 12. The supporting bracket 12 is located under and is disposed opposite to the holding container 11. The supporting bracket 12 is spaced from the holding container 11 to form a first accommodating space 13 arranged between a bottom of the holding container 11 and a top surface of the supporting bracket 12. The first accommodating space 13 is recessed from a front end of the base body 10 to a rear end of the base body 10 and penetrating through a front surface of the base body 10 to make the front end of the base body 10 be shown as a U shape seen from a side view.

In order to describe conveniently and more clearly, in this description, the front end of the base body 10 is defined as one end that is closer to a user. A mouth of the first accommodating space 13 faces towards the user. An inner surface of a top wall of the first accommodating space 13 is parallel to an inner surface of a bottom wall of the first accommodating space 13, and the inner surfaces of the top wall and the bottom wall of the first accommodating space 13 are parallel to a top surface and a bottom surface of the base body 10. The holding container 11 and the supporting bracket 12 are disposed to mounted to the inner surfaces of the top wall and the bottom wall of the first accommodating space 13. The holding container 11 is located on the inner surface of the top wall of the first accommodating space 13. The supporting bracket 12 is disposed under the inner surface of the bottom wall of the first accommodating space 13. The first accommodating space 13 is used for holding a coffee cup 50 on the supporting bracket 12.

The cover 20 is movably and pivotally connected to the upper surface of the base body 10. The cover 20 includes a pivot end 20a that is pivotally connected to the base body 10, a free end 20b opposite to the pivot end 20a, and a cutting membrane structure 21 arranged between the pivot end 20a and the free end 20b. The cover 20 is equipped with a blade holder 22 in alignment with the holding container 11 at the time of the cover 20 being closed. The blade holder 22 has a plurality of water outlets 21a arranged around the blade holder 22, and a plurality of blades 24 arranged at the blade holder 22. The plurality of the blades 24 are inclined downward and are disposed around the blade holder 22. Each blade 24 is cooperated with one water outlet 21a for guiding water flow out. The flip lid coffee machine 100 further includes an actuator 30, an image sensing camera 46 for capturing a two-dimension bar code on a top membrane of the coffee capsule 60, an image processing unit 41 and a microprocessor 43. The actuator 30 is connected between the base body 10 and the pivot end 20a of the cover 20 to drive the cover 20. The image sensing camera 46 is arranged at and is exposed to the free end 20b of the cover 20. The image sensing camera 46 is exposed out of a front of the cover 20. The image sensing camera 46 is disposed towards the holding container 11 for capturing an image of the holding container 11 at the time of the cover 20 being opened. The image processing unit 41 is used for identifying the image of the holding container 11 captured by the image sensing camera 46, and the microprocessor 43 is used for controlling the actuator 30 according to an identify result of the image processing unit 41.

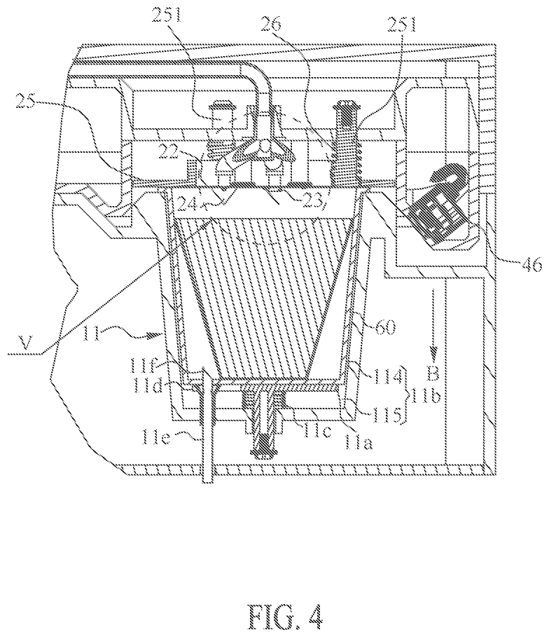

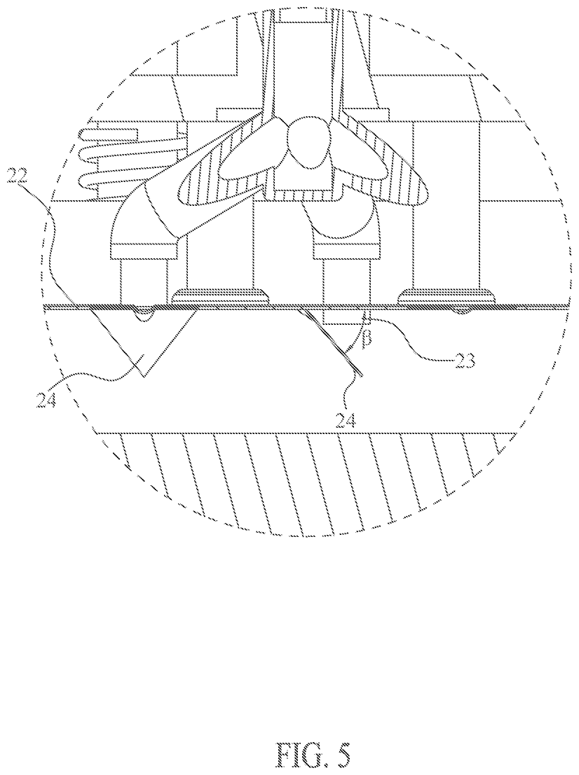

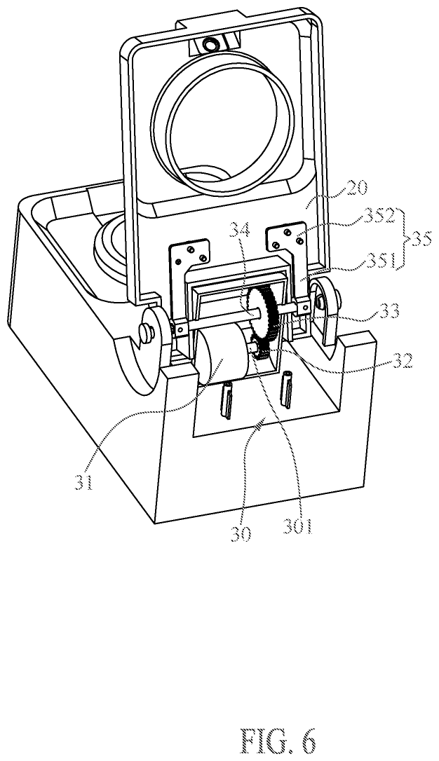

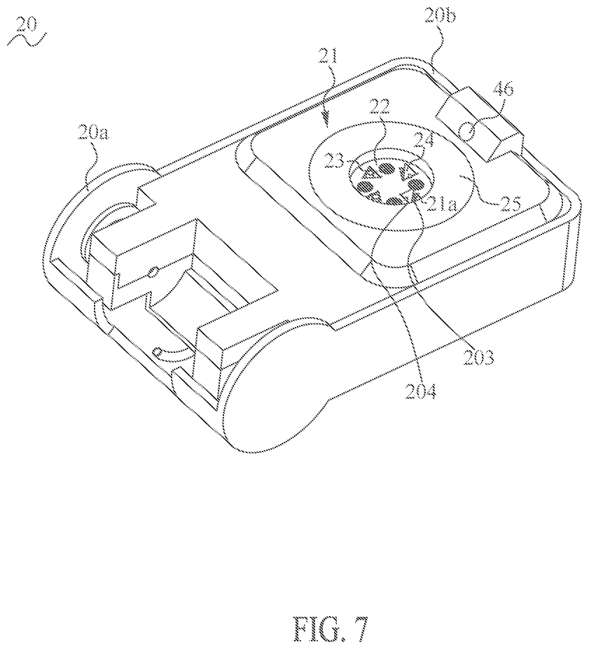

Referring to FIG. 2 to FIG. 7, in order to slow down an impact force of a hot water stream so as to make the hot water stream distributed on surfaces of the coffee particles more evenly for extracting the coffee more efficiently and more evenly. In the preferred embodiment, when the cover 20 is covered on the upper surface of the base body 10, the cutting membrane structure 21 is aligned with the holding container 11. The cutting membrane structure 21 includes the blade holder 22, the plurality of the water outlets 21a and the plurality of the blades 24. The plurality of the water outlets 21a are arranged around a periphery of the blade holder 22. The plurality of the blades 24 are arranged around the periphery of the blade holder 22 and corresponding to the plurality of the water outlets 21a. The plurality of the blades 24 are cooperated with the plurality of the water outlets 21a, and each blade 24 is disposed corresponding to a water flowing direction of one water outlet 21a for guiding a water stream.

Specifically, the cutting membrane structure 21 further includes an upper ring 25, a plurality of elastic elements 26 and a plurality of hot water conduits 23. The upper ring 25 is annular. The cutting membrane structure 21 and the blade holder 22 are assembled in the cover 20. The cover 20 defines an opening 201 penetrating through a middle of a bottom surface of the cover 20. The blade holder 22, the upper ring 25 and the plurality of the hot water conduits 23 are exposed to the opening 201. The plurality of the elastic elements 26 are mounted around an inner surface of the upper ring 25. Several portions of the inner surface of the upper ring 25 protrude perpendicular to the inner surface of the upper ring 25 to form a plurality of fixing pillars 251. The plurality of the elastic elements 26 are mounted around the plurality of the fixing pillars 251. The plurality of the elastic elements 26 are mounted to a periphery of a top of the upper ring 25 for supporting the upper ring 25. The plurality of the elastic elements 26 elastically abut between an upper portion of the cover 20 and a top surface of the upper ring 25. The plurality of the hot water conduits 23 are disposed around an assembling surface 222 of the blade holder 22 opposite to the holding container 11. The plurality of the hot water conduits 23 are corresponding to the plurality of the water outlets 21a. The upper ring 25 is mounted around the blade holder 22 for securing the blade holder 22, and the upper ring 25 and the blade holder 22 are concentric. A first exposing surface 252 of the upper ring 25 towards the holding container 11 projects beyond a second exposing surface 221 of the blade holder 22 towards the holding container 11. The plurality of the blades 24 and the plurality of the water outlets 21a are triangles. Tail ends of the plurality of the hot water conduits 23 are exposed to the second exposing surface 221 of the blade holder 22 through the plurality of the water outlets 21a.

An edge of each blade 24 is correspondingly connected with a side wall of one water outlet 21a. Each blade 24 is cut from the blade holder 22 and has a V-shape cut edge 203, and a bending edge 204 of each blade 24 is connected with the blade holder 22. One side of each blade 24 is located under one side of the one water outlet 21a, and an inclination angle R is formed between the one side of each blade 24 and the one side of the one water outlet 21a. The inclination angle R is formed between an upper surface of the one side of each blade 24 and a bottom of the one side of the one water outlet 21a. Inclination directions of the inclination angles R among the plurality of the blades 24 and the plurality of the water outlets 21a are the same. Degrees of the inclination angles R among the plurality of the blades 24 and the plurality of the water outlets 21a are the same. The degrees of the inclination angles R among the plurality of the blades 24 and the plurality of the water outlets 21a are ranged between forty-five degrees and sixty degrees. Preferably, the degree of the inclination angle R between the upper surface of the one side of each blade 24 and the one side of the one water outlet 21a is more than forty-five degrees and is less than sixty degrees.

Each blade 24 is bent towards the holding container 11 in an angle which is more than forty-five degrees and is less than sixty degrees to ensure a tool tip of each blade 24 facing towards the holding container 11. An intersection angle formed between each blade 24 and the one water outlet 21a is towards the holding container 11. The intersection angle formed between each blade 24 and the one water outlet 21a is the inclination angle β. A lower portion of the holding container 11 is equipped with a propping element 11a spaced from a bottom wall of the holding container 11. An inside of the holding container 11 has a receiving space 11b penetrating through the top surface of the holding container 11. The propping element 11a is received in a lower portion of the receiving space 11b. The receiving space 11b is divided into a first receiving space 114 and a second receiving space 115 by the propping element 11a. The second receiving space 115 is located under the first receiving space 114, and the first receiving space 114 is used for receiving the coffee capsule 60. An inside of the coffee capsule 60 has coffee.

A middle of a bottom surface of the holding container 11 protrudes downward to form a hollow fastening pillar 111. A middle of the fastening pillar 111 has an insertion hole 113 penetrating through a bottom surface of the fastening pillar 111. The flip lid coffee machine 100 further includes an elastic component 11c disposed in the lower portion of the holding container 11. The elastic component 11c is mounted in the second receiving space 115 of the receiving space 11b. The elastic component 11c is mounted around an upper portion of the fastening pillar 111. A middle of a bottom wall of the holding container 11 has a penetrating hole 112. A lower portion of the fastening pillar 111 passes through the penetrating hole 112 of the holding container 11, and the fastening pillar 111 is fixed to the holding container 11 by virtue of an upper portion of a screw 70 being screwed in the insertion hole 113 and a lower portion of the screw 70 being blocked by a bottom surface of the fastening pillar 111 and a bottom surface of a wall of the insertion hole 113.

The elastic component 11c contacts with and props upward against a bottom surface of a periphery of the propping element 11a. The propping element 11a is movable with respect to the holding container 11 along an up-down direction. One side of the propping element 11a has a guiding hole 11d vertically penetrating through the propping element 11a. The holding container 11 is equipped with a coffee pipe 11e arranged to the second receiving space 115 of the lower portion of the holding container 11 and vertically arranged under the guiding hole 11d. The coffee pipe lie is vertically disposed to the propping element 11a to be aligned with the guiding hole 11d. A bottom of the coffee pipe lie projects beyond the bottom surface of the holding container 11. A top end of the coffee pipe 11e has a piercing tip 11f close to a bottom of the guiding hole 11d. When the coffee capsule 60 is positioned on the propping element 11a and is positioned in the first receiving space 114 of the receiving space 11b, the propping element 11a is pressed downward under a weight of the coffee capsule 60, the piercing tip 11f projects into the second receiving space 115 of the receiving space 11b and is located in the guiding hole 11d, and the top end of the piercing tip 11f passes through the guiding hole 11d to enter the first receiving space 114 of the receiving space 11b and further pierce the coffee capsule 60.

Referring to FIG. 2 to FIG. 5, when the cover 20 is covered to the holding container 11, the upper ring 25 abuts against a top membrane of the coffee capsule 60 to press and fasten the coffee capsule 60 in the first receiving space 114 of the receiving space 11b at first. The first exposing surface 252 of the upper ring 25 towards the holding container 11 is flush with the second exposing surface 221 of the blade holder 22 towards the holding container 11 by virtue of the plurality of the elastic elements 26 being compressed against the upper ring 25. With the plurality of the elastic elements 26 being further compressed, the upper ring 25 stays above the coffee capsule 60 due to compressions of the plurality of the elastic elements 26 and makes the blade holder 22 and the plurality of the blades 24 exposed out of the upper ring 25, and the plurality of the blades 24 cut through the top membrane of the coffee capsule 60. Bottom ends of the plurality of the hot water conduits 23 have outlet holes 231. And the outlet holes 231 of the plurality of the hot water conduits 23 through which water streams flow out are partially blocked by the plurality of the blades 24 which are designed to be inclined downward to guide the water streams. Meanwhile, when the coffee capsule 60 is pressed into and fastened in the first receiving space 114 of the receiving space 11b, the propping element 11a is pressed towards a direction (B) under a pushing force of the coffee capsule 60, the propping element 11a moves downward and towards the direction (B) to further compress the elastic component 11c, and the top end of the piercing tip 11f is made to pass through the guiding hole 11d and enter the receiving space 11b. The piercing tip 11f pierces a bottom of the coffee capsule 60, and the coffee pipe 11e guides coffee to flow into a coffee cup 50.

Referring to FIG. 1 to FIG. 3, when the cover 20 is lifted to be away from the connecting hole 116 of the holding container 11, the elastic component 11c pushes the coffee capsule 60 to move upward and towards a direction opposite to the direction (B) under an opposite elasticity force of the elastic component 11c to eject a top end of the coffee capsule 60 exposed outside from the connecting hole 116 of the holding container 11 so as to be convenient for a user to take or discard the coffee capsule 60.

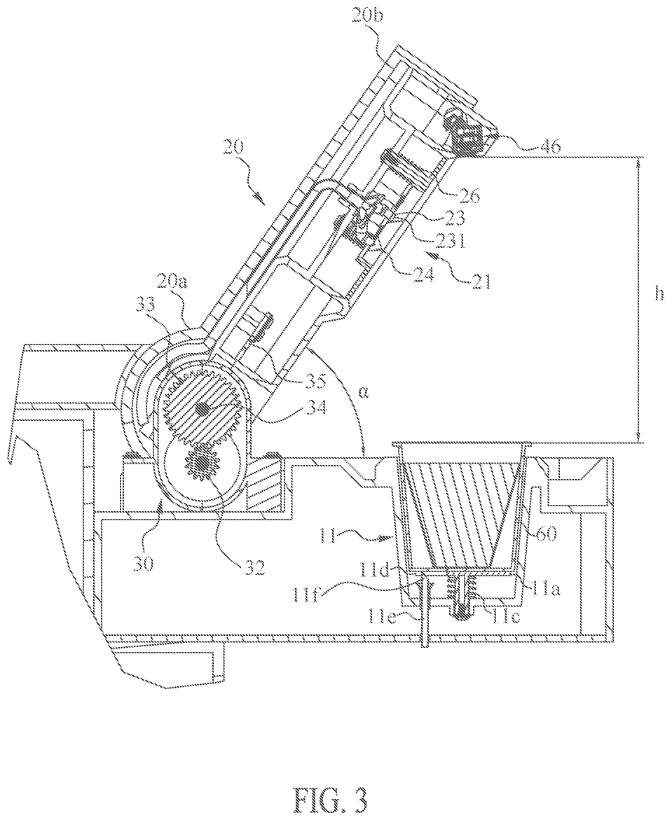

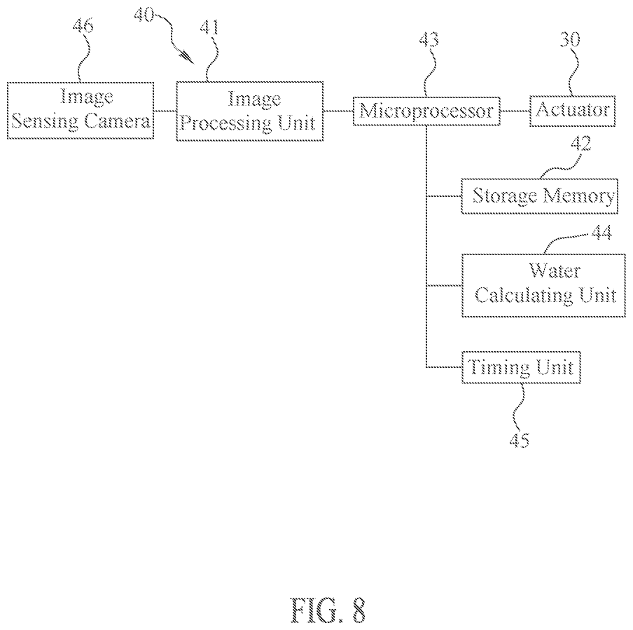

Referring to FIG. 3 to FIG. 8, in the preferred embodiment, in order to further improve a convenience and a quickness of the flip lid coffee machine 100, and make the flip lid coffee machine 100 reach a more intelligent effect so as to improve a competitive function of the flip lid coffee machine 100, the flip lid coffee machine 100 includes the actuator 30 disposed and connected between the base body 10 and the pivot end 20a, the image sensing camera 46 arranged at the free end 20b of the cover 20, and a control device 40 connected with and communicating with the actuator 30 and the image sensing camera 46.

The control device 40 includes the image processing unit 41 for receiving image data of the captured two-dimension bar code and proceeding with an image recognition of the captured two-dimension bar code, a storage memory 42 for storing a recognized image, the microprocessor 43 for processing confirmation data of the captured two-dimension bar code, and starting and controlling the actuator 30 and the cover 20, a water calculating unit 44 for calculating a water injection rate, and a timing unit 45 for calculating waiting time.

The actuator 30 includes a server motor 31 fastened to a top surface of the base body 10 and connected with the microprocessor 43, a driving gear 32 connected with a rotation shaft 301 of the server motor 31, a follower gear 33 engaged with the driving gear 32, and a fastening shaft 34 penetrating through an axis center of the follower gear 33, and two fastening frames 35 respectively fastened to two opposite ends of the fastening shaft 34. The two opposite ends of the fastening shaft 34 are connected to the cover 20. The two fastening frames 35 are shown as L shapes. Each fastening frame 35 has a long arm 351, and a short arm 352 perpendicularly connected with one end of the long arm 351. The other ends of the long arms 351 of the two fastening frames 35 are connected with the two opposite ends of the fastening shaft 34. The short arms 352 of the two fastening frames 35 are fastened to the cover 20. The two short arms 352 of the two fastening frames 35 have two facing ends. When the cover 20 is lifted, the one ends of the long arms 351 and the short arms 352 of the two fastening frames 35 are located above the fastening shaft 34. When the cover 20 is covered to the holding container 11, the one ends of the long arms 351 and the short arms 352 of the two fastening frames 35 are located in front of the fastening shaft 34. The driving gear 32 is driven by virtue of the rotation shaft 301 of the server motor 31 rotating clockwise or anticlockwise, and then the driving gear 32 drives the follower gear 33 to make the two fastening frames 35 drive the cover 20 to automatically cover the holding container 11 or move upward away from the holding container 11 to open the holding container 11.

Referring to FIG. 2 to FIG. 8, the image sensing camera 46 is exposed to the free end 20b of the cover 20, and when the cover 20 is moved to a range of an oblique angle α, the image sensing camera 46 is towards the connecting hole 116 of the holding container 11 and captures the two-dimension bar code on the top membrane of the coffee capsule 60 positioned in the holding container 11. Specifically, a lens 401 of the image sensing camera 46 is inclined towards the upper surface of the base body 10 connected with the cover 20. The cover 20 is movable with respect to the holding container 11 of the base body 10, and the oblique angle α is formed between the cover 20 and the top surface of the holding container 11, and the oblique angle α is ranged between fifty-one degrees and sixty-one degrees. The oblique angle α is more than fifty-one degrees and is less than sixty-one degrees. With a variation of the oblique angle α, when a distance between the free end 20b of the cover 20 and the top surface of the holding container 11 is ranged between one hundred and twenty-eight millimeters and one hundred and fifty millimeters, the image sensing camera 46 is towards the connecting hole 116 of the holding container 11.

Referring to FIG. 1 to FIG. 8, in specific, at first, when the user extracts the coffee, a power supply (not shown) of the flip lid coffee machine 100 is connected to an external power source (not shown) and is turned on, the free end 20b of the cover 20 moves away from the top surface of the holding container 11 by virtue of the server motor 31 automatically rotating clockwise. Then, the user places the coffee capsule 60 in the first receiving space 114 of the receiving space 11b of the holding container 11, and touches a starting button (not shown) of the flip lid coffee machine 100 which is electrically connected with the control device 40.

Next, controlling steps of the flip lid coffee machine 100 extracting the coffee are described as follows.

Drive the server motor 31 to automatically rotate anticlockwise by the microprocessor 43. The free ends 20b of the cover 20 gradually approaches the top surface of the holding container 11 and covers the holding container 11. Simultaneously, the cover 20 rotates within the range of the oblique angle α which is between fifty-one degrees and sixty-one degrees to make the image sensing camera 46 be towards the holding container 11 and capture the two-dimension bar code on the top membrane of the coffee capsule 60 positioned in the holding container 11. The two-dimension bar code on the top membrane of the coffee capsule 60 is a quick response (QR) code.

Recognize the image data by the image processing unit 41, and then compare an image recognition result with data stored in the storage memory 42 in advance by the microprocessor 43, so that a brewing coffee procedure is preset, got and stored.

According to the brewing coffee procedure stored in advance, pour corresponding hot water from the plurality of the plurality of the hot water conduits 23 into the coffee capsule 60 by the water calculating unit 44, simultaneously, wait for an expected time by the timing unit 45.

After completing the preset brewing coffee procedure, the microprocessor 43 drives the rotation shaft 301 of the server motor 31 to rotate clockwise again until the cover 20 moves away from the holding container 11. Later, the user discards the used coffee capsule 60 of which the coffee is brewed.

At last, turn off the power supply of the flip lid coffee machine 100, the server motor 31 rotates anticlockwise again until the free end 20b of the cover 20 is covered to the holding container 11.

In a process of the cover 20 rotating, besides the image sensing camera 46 captures the two-dimension bar code on the top membrane of the coffee capsule 60, if a foreign material is located around the holding container 11, the cover 20 will automatically stop working until the foreign material is cleared away, and after the power supply of the flip lid coffee machine 100 is turned on again, the cover 20 is able to work again.

As described above, in a process of the flip lid coffee machine 100 extracting the coffee, the image sensing camera 46 captures the two-dimension bar code on the top membrane of the coffee capsule 60, so the flip lid coffee machine 100 is easy to use. Moreover, the plurality of the water outlets 21a are arranged around the periphery of the blade holder 22, the plurality of the blades 24 are arranged around the periphery of the blade holder 22 and corresponding to the plurality of the water outlets 21a, and the plurality of the hot water conduits 23 are corresponding to the plurality of the water outlets 21a, so the coffee is more uniformly extracted and is able to be brewed evenly.

What is claimed is:

1. A flip lid coffee machine, comprising:
a base body;
a holding container penetrating through an upper surface of the base body;
a cover movably and pivotally connected to the upper surface of the base body, the cover having a pivot end that is pivotally connected to the base body, a free end opposite to the pivot end, and a cutting membrane structure arranged between the pivot end and the free end, when the cover is covered on the upper surface of the base body, the cutting membrane structure being aligned with the holding container, the cutting membrane structure including a blade holder, a plurality of the water outlets and a plurality of blades, the plurality of the water outlets being arranged around a periphery of the blade holder, the plurality of the blades being arranged around the periphery of the blade holder and corresponding to the plurality of the water outlets, each blade being disposed corresponding to a water flowing direction of one water outlet for guiding a water stream, and an oblique angle being formed between the cover and a top surface of the holding container;
an actuator connected between the base body and the pivot end of the cover;
an image sensing camera arranged at and exposed to the free end of the cover, the holding container having a connecting hole penetrating through the top surface of the holding container, when the cover is moved to a range of the oblique angle, the image sensing camera being towards the connecting hole of the holding container; and
a control device connected with and communicating with the actuator and the image sensing camera, the control device including an image processing unit for receiving image data and proceeding with an image recognition, and a microprocessor for processing confirmation data and starting the actuator.

2. The flip lid coffee machine as claimed in claim 1, wherein a lower portion of the holding container is equipped with a propping element spaced from a bottom wall of the holding container, an inside of the holding container has a receiving space penetrating through the top surface of the holding container, the flip lid coffee machine further includes an elastic component disposed in the lower portion of the holding container, the elastic component contacts with and props upward against a bottom surface of a periphery of the propping element, one side of the propping element has a guiding hole vertically penetrating through the propping element, the holding container is equipped with a coffee pipe arranged to the lower portion of the holding container and vertically arranged under the guiding hole, a top end of the coffee pipe has a piercing tip close to a bottom of the guiding hole, when a coffee capsule is positioned on the propping element, the propping element is pressed downward under a weight of the coffee capsule, the piercing tip passes through the guiding hole to enter the receiving space and further pierce the coffee capsule.

3. The flip lid coffee machine as claimed in claim 1, wherein the actuator includes a server motor fastened to a top surface of the base body and connected with the microprocessor, a driving gear connected with a rotation shaft of the server motor, a follower gear engaged with the driving gear, and a fastening shaft penetrating through an axis center of the follower gear, two opposite ends of the fastening shaft are connected to the cover.

4. The flip lid coffee machine as claimed in claim 3, wherein the actuator includes two fastening frames respectively fastened to the two opposite ends of the fastening shaft, the two fastening frames are shown as L shapes, each fastening frame has a long arm, and a short arm perpendicularly connected with one end of the long arm, the other ends of the long arms of the two fastening frames are connected with the two opposite ends of the fastening shaft, the short arms of the two fastening frames are fastened to the cover, the driving gear is driven by virtue of the rotation shaft of the server motor rotating clockwise or anticlockwise, and then the driving gear drives the follower gear to make the two fastening frames drive the cover to automatically covered to the holding container or moved upward away from the holding container to open the holding container.

5. The flip lid coffee machine as claimed in claim 1, wherein the cutting membrane structure includes a upper ring and a plurality of elastic elements, the upper ring is annular, the plurality of the elastic elements are mounted around an inner surface of the upper ring, the upper ring is mounted around the blade holder, and the upper ring and the blade holder are concentric, a first exposing surface of the upper ring towards the holding container projects beyond a second exposing surface of the blade holder towards the holding container.

6. The flip lid coffee machine as claimed in claim 5, wherein the cutting membrane structure includes a plurality of hot water conduits disposed around an assembling surface of the blade holder opposite to the holding container, the plurality of the hot water conduits are corresponding to the plurality of the water outlets.

7. The flip lid coffee machine as claimed in claim 5, wherein the cutting membrane structure includes a plurality of hot water conduits disposed around an assembling surface of the blade holder opposite to the holding container, tail ends of the plurality of the hot water conduits are exposed to the second exposing surface of the blade holder through the plurality of the water outlets, the plurality of the hot water conduits through which water streams flow out are partially blocked by the plurality of the blades to guide the water streams.

8. The flip lid coffee machine as claimed in claim 1, wherein the plurality of the blades and the plurality of the water outlets are triangles, an edge of each blade is correspondingly connected with a side wall of the one water outlet, one side of each blade is located under one side of the one water outlet, and an inclination angle is formed between the one side of each blade and the one side of the one water outlet, inclination directions of the inclination angles among the plurality of the blades and the plurality of the water outlets are the same, degree of the inclination angle between the one side of each blade and the one side of the one water outlet is more than forty-five degrees and is less than sixty degrees.

9. The flip lid coffee machine as claimed in claim 1, wherein an intersection angle formed between each blade and the one water outlet is towards the holding container.

10. The flip lid coffee machine as claimed in claim 1, wherein each blade is cut from the blade holder and has a V-shape cut edge, and a bending edge of each blade is connected with the blade holder.

11. The flip lid coffee machine as claimed in claim 1, wherein a lens of the image sensing camera is inclined towards the upper surface of the base body connected with the cover, the cover is movable with respect to the holding container, and an oblique angle is formed between the cover and the top surface of the holding container, and the oblique angle is more than fifty-one degrees and is less than sixty-one degrees, with a variation of the oblique angle, when a distance between the free end of the cover and the top surface of the holding container is ranged between one hundred and twenty-eight millimeters and one hundred and fifty millimeters, the image sensing camera is towards the connecting hole of the holding container.

12. The flip lid coffee machine as claimed in claim 1, wherein the control device includes a storage memory for storing a recognized image, a water calculating unit for calculating a water injection rate, and a timing unit for calculating waiting time.

13. The flip lid coffee machine as claimed in claim 1, wherein a lower portion of the holding container is equipped with a propping element spaced from a bottom wall of the holding container, the receiving space is divided into a first receiving space and a second receiving space by the propping element, the second receiving space is located under the first receiving space, and the first receiving space is used for receiving a coffee capsule, the holding container is equipped with a coffee pipe arranged to the second receiving space, the flip lid coffee machine further includes an elastic component mounted in the second receiving space, the elastic component contacts with and props upward against a bottom surface of a periphery of the propping element, the propping element is movable with respect to the holding container along an up-down direction.

14. The flip lid coffee machine as claimed in claim 1, wherein the cover rotates within the range of the oblique angle formed between the cover and the top surface of the holding container to make the image sensing camera be towards the holding container and capture a two-dimension bar code on a top membrane of a coffee capsule positioned in the holding container.

15. A flip lid coffee machine adapted for extracting coffee from a coffee capsule, comprising:
a base body;
a holding container mounted to an upper surface of the base body;
a cover movably and pivotally connected to the upper surface of the base body, the cover having a pivot end that is pivotally connected to the base body, a free end opposite to the pivot end, and a cutting membrane structure arranged between the pivot end and the free end, when the cover is covered on the upper surface of the base body, the cutting membrane structure being aligned with the holding container, the cutting membrane structure including a blade holder, a plurality of the water outlets and a plurality of blades, the plurality of the water outlets being arranged around a periphery of the blade holder, the plurality of the blades being arranged around the periphery of the blade holder and corresponding to the plurality of the water outlets, each blade being disposed corresponding to a water flowing direction of one water outlet for guiding a water stream, the cover being movable with respect to the holding container, and an oblique angle being formed between the cover and a top surface of the holding container;
an actuator connected between the base body and the pivot end of the cover;
an image sensing camera arranged at and exposed to the free end of the cover, the holding container having a connecting hole penetrating through the top surface of the holding container for receiving the coffee capsule, when the cover is moved to a range of the oblique angle, the image sensing camera being towards the connecting hole of the holding container; and
a control device connected with and communicating with the actuator and the image sensing camera, the control device including an image processing unit for receiving image data and proceeding with an image recognition, and a microprocessor for processing confirmation data and controlling the actuator,
wherein the cover rotates within the range of the oblique angle to make the image sensing camera be towards the holding container and capture a two-dimension bar code on a top membrane of the coffee capsule.

16. The flip lid coffee machine as claimed in claim 15, wherein the oblique angle is more than fifty-one degrees and is less than sixty-one degrees.

17. A flip lid coffee machine, comprising:
a base body;
a holding container mounted to an upper surface of the base body;
a cover movably and pivotally connected to the upper surface of the base body, the cover having a pivot end that is pivotally connected to the base body, a free end opposite to the pivot end, and a cutting membrane structure arranged between the pivot end and the free end, when the cover is covered on the upper surface of the base body, the cutting membrane structure being aligned with the holding container, the cutting membrane structure including a blade holder, a plurality of the water outlets, a plurality of blades and a plurality of hot water conduits, the plurality of the water outlets being arranged around a periphery of the blade holder, the plurality of the blades being arranged around the periphery of the blade holder and corresponding to the plurality of the water outlets, each blade being disposed corresponding to a water flowing direction of one water outlet for guiding a water stream, the plurality of the hot water conduits being disposed around an assembling surface of the blade holder opposite to the holding container, the plurality of the hot water conduits being corresponding to the plurality of the water outlets, and an oblique angle being formed between the cover and a top surface of the holding container;
an actuator connected between the base body and the pivot end of the cover;
an image sensing camera arranged at and exposed to the free end of the cover, the holding container having a connecting hole penetrating through the top surface of the holding container, when the cover is moved to a range of the oblique angle, the image sensing camera being towards the connecting hole of the holding container and capturing a two-dimension bar code on a top membrane of a coffee capsule positioned in the holding container; and
a control device connected with and communicating with the actuator and the image sensing camera, the control device including an image processing unit for receiving image data of the captured two-dimension bar code and proceeding with an image recognition of the captured two-dimension bar code, and a microprocessor for processing confirmation data of the captured two-dimension bar code and controlling the actuator.
